(19) United States
(12) Patent Application Publication
(10) Pub. No.: US 2006/0246887 A1
(43) Pub. Date: Nov. 2, 2006

(54) Mapping of weak RF signal areas in a wireless telecommunication system using customers' mobile units

(76) Inventors: Deborah L. Barclay, Winfield, IL (US); David S. Benco, Winfield, IL (US); Sanjeev Mahajan, Naperville, IL (US); Thomas L. McRoberts, Naperville, IL (US); Raymond L. Ruggerio, Glenview, IL (US)

Correspondence Address: CARMEN B. PATTI & ASSOCIATES, LLC, ONE NORTH LASALLE STREET, 44TH FLOOR, CHICAGO, IL, 60602, US

(21) Appl. No.: 11/119,975

(22) Filed: May 2, 2005

(51) Int. Cl. H04B 17/00; H04Q 7/20

(52) U.S. Cl. 455/423; 455/67.11

(57) ABSTRACT

An exemplary wireless mobile device includes an RF transmitter and receiver where the receiver monitors signal strength of an RF signal from a base station. A control logic module compares the signal strength to a comparison level. The control logic module creates and stores a record in a memory module. The record includes a first signal strength level and parameters related to conditions existing at the time the comparing was done. The control logic module creates and stores the record if the level of said signal strength is less than the comparison level.

### BACKGROUND

This invention relates generally to wireless communication systems and more specifically to determining locations of weak radio frequency (RF) signal coverage within areas where communication services are to be provided.

Cellular network providers use a plurality of overlapping cells in an effort to provide continuous communication services to mobile users within predetermined geographic regions. However, even within the predetermined geographic regions there will typically be areas of low RF signal strength which correspond to poor, if any, quality of communications. Such areas may be referred to as dead or weak coverage areas. For a cellular mobile user that moves into such an area during an existing call, the quality of the communications will degrade or the call may be dropped.

Known techniques for identifying such low signal strength areas include having technicians drive around in areas thought to have low signal strength in vehicles equipped to continuously log and monitor signal strength from one or more base stations in the telecommunication network. Such work is time consuming and may not locate all weak RF signal coverage areas. For example, a user with a hand-held cellular telephone may move through locations with signal strength characteristics that differ substantially from a signal strength measurement made from the nearest road. Thus, there exists a need for a more flexible and easier to utilize method to map areas of weak signal strength within a region in which communication services are to be provided.

### SUMMARY

The invention in one implementation encompasses an exemplary wireless mobile device that includes an RF transmitter and receiver where the receiver monitors signal strength of a radio frequency (RF) signal from a base station. A control logic module compares the signal strength to a comparison level. The control logic module creates and stores a record in a memory module. The record includes a first signal strength level and parameters related to conditions existing at the time the comparing was done. The control logic module creates and stores the record if the level of said signal strength is less than the comparison level.

Another implementation of the invention encompasses a method for collecting signal strength data for a wireless system. Signal strength of a radio frequency (RF) signal received from a base station is monitored by a mobile device. The level of the signal strength is compared to a comparison level. If the level of the signal strength is less than the comparison level, a record is created and stored in the mobile device where the record includes a first signal strength level and parameters related to conditions existing at the time the comparing was done.

A further implementation of the invention encompasses an article. The article comprises one or more computer-readable signal-bearing media. The article includes means in the one or more media for practicing the actions of the above method.

### DESCRIPTION OF THE DRAWINGS

Features of exemplary implementations of the invention will become apparent from the description, the claims, and the accompanying drawings in which:

FIG. 1 is a diagram of a telecommunication system suited for implementing an exemplary method in accordance with the present invention.

FIG. 2 is a block diagram of an exemplary wireless mobile communication device in accordance with an embodiment of the present invention.

FIG. 3 is a flow diagram of an embodiment of an exemplary method for collecting data relating to weak signal strength areas in accordance with the present invention.

FIG. 4 is a flow diagram of an embodiment of an exemplary method for transmitting data relating to weak signal strength to a database in accordance with the present invention.

FIG. 5 is a flow diagram of an embodiment of an exemplary method for minimizing the amount of weak signal strength records to be transmitted to a database in accordance with the present invention.

### DETAILED DESCRIPTION

The concepts in accordance with the present invention are applicable in a variety of wireless communication environments. Although the embodiments of the present invention are described with regard to a cellular communication system, the concepts of the present invention are generally applicable to wireless communication systems in which mobile/portable transceivers are utilized. As used herein a “mobile device” refers to an RF communication device intended to support communications while the transceiver moves between locations, e.g. a transceiver mounted in a vehicle or a hand-held transceiver carried by a person.

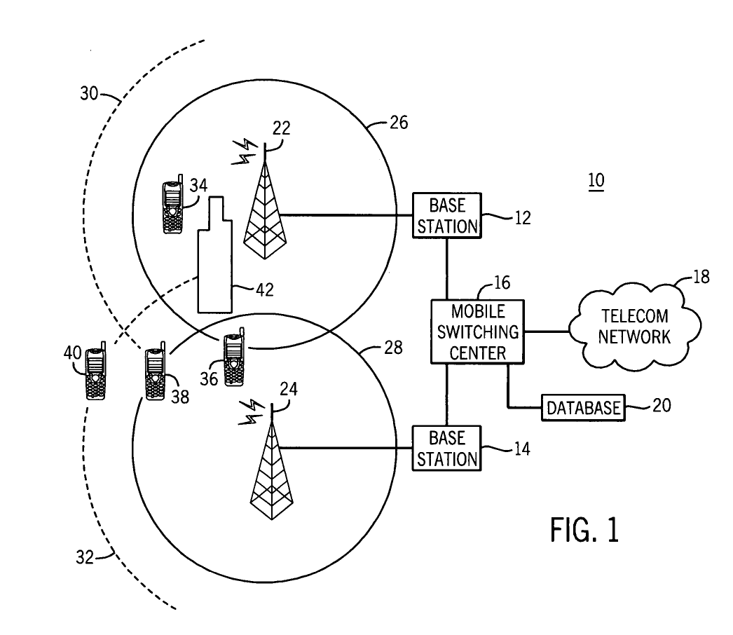

FIG. 1 illustrates a wireless communication system 10 suited to provide cellular communications. Base stations 12 and 14 are part of the wireless infrastructure equipment and utilize RF transmitters and receivers for supporting wireless communications with a plurality of mobile devices. The base stations are supported by and coupled to a mobile switching center 16 that provides telecommunication switching facilities to route calls to and from the mobile users. The mobile switching center 16 is also coupled to the telecommunication network 18 that supports communications with other systems and users, and may comprise at least in part the public switched telecommunication network. An exemplary database 20 is coupled to the mobile switching center 16 and provides a location to store information related to weak signal strength areas as will be explained in detail below. The database could be located elsewhere or embodied within an existing network element.

Cellular antennae 22 and 24 are coupled to base stations 12 and 14, respectively. Cellular antennae 22 and 24 are designed to support communications with wireless devices within cells 26 and 28, respectively. Cells 26 and 28 have corresponding extended coverage areas 30 and 32 in which communications can be supported under favorable conditions with mobile devices in these extended coverage areas. However, coverage within the extended areas will become increasingly marginal as the mobile user moves farther away from the respective base station cellular antenna.

Mobile device 34 is clearly within the primary area of coverage of cell 26 and is served by antenna 22 and base station 12. (Reference herein to a mobile device or a mobile user may be used interchangeably with it being apparent from context as to whether reference is being made to the device itself or the user of the device.) Mobile device 36 is located within the primary area of coverage of both cells 26 and 28, i.e. located within an area of overlap. This device may be served by either antenna and its corresponding base station. If the corresponding user is moving in a direction generally towards the center of cell 26 or 28, then a hand off will be made if the mobile device was being previously supported by the other cell. Mobile device 38 is outside of the primary coverage of cells 26 and 28, but within the extended coverage areas 30 and 32 of these respective cells. Assuming no other cell is present to provide service, it may be served by either antenna 22 or 24. Mobile device 40 is just outside of the extended coverage areas 30 and 32. Mobile device 40 may be served by either antenna 22 or 24 with what will likely be a marginal strength signal.

In the above paragraph, mobile devices were described in terms of location relative to the respective cellular antennae, and hence relative to designed areas of coverage for each respective cell. In a relatively unobstructed RF environment, the signal strength between the mobile device and the cellular antenna will typically diminish proportional to increasing distance. Thus, as the mobile device moves further away from the cellular antenna, the signal strength will diminish and will eventually reach a level at which communications cannot be maintained. However, an obstruction such as a tall building 42 can give rise to what is known as a shadow that is normally cast in the direction away from the transmitting antenna. For example, building 42 may be located so as to cast an RF shadow with regard to antenna 22 that extends to mobile device 36. Assuming that the mobile device 36 is being served by antenna 22 and has moved from a first location within cell 26 having no shadow from building 42 to a position in which it encounters a shadow from building 42, a significant loss of signal strength will likely result. It will be noted that this loss of signal strength is within the intended area of primary coverage 26 for antenna 22. Additionally, other conditions even within an intended area of primary coverage may give rise to a significant loss of signal strength such as a tunnel, bridge, etc.

One object of the embodiment of the present invention is to provide a map of locations with low signal strength within a region in which telecommunications services are to be provided. In a preferred implementation it is desirable only to map those locations with low signal strength that may be reasonably remedied. That is, an elevator compartment completely enclosed by metal within the intended communication region may give rise to unacceptably low signal strengths, but a reasonable and economically justified remedy may not be available. Another aspect resides in balancing the amount of signal strength map information to transmit to an infrastructure database versus the bandwidth needed for such transmission.

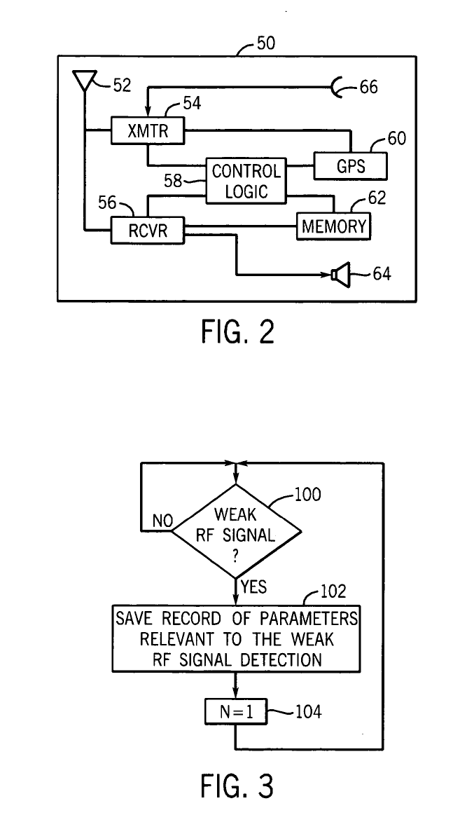

FIG. 2 is a block diagram of an exemplary wireless mobile communication device 50 in accordance with the present invention. It includes an antenna 52 that is coupled to a transmitter module 54 and a receiver module 56. A control logic module 58 is connected to the transmitter and receiver modules as well as other elements. The control logic module may consist of a microprocessor operating under the control of stored program instructions. A global positioning satellite (GPS) module 60 preferably provides latitude, longitude and altitude information that identifies the location of the mobile device. Memory 62 is utilized in accordance with the present invention to store records relating to weak RF signal determinations as will be explained in more detail below. The receiver module 56 is connected to a speaker 64 and the transmitter module 54 is connected to a microphone 66. The control logic 58 in cooperation with the other elements effectuates the generation of records having weak signal strength parameters and facilitates the automatic transmission of these records to the database 20. The control logic module 58 may also perform the normal functions and requirements associated with the control and operation of a mobile device such as a cellular telephone.

A general description of the operation of the illustrated embodiment will be helpful in understanding the flow diagrams described below. The mobile device continuously monitors the signal strength of the received RF signal from at least the base station antenna currently providing communications support. In a preferred implementation, other received RF signals from other base stations are also monitored with regard to signal strength. This monitoring occurs whenever the mobile device is ON, i.e. during a conversation and during times when the mobile device is merely active and capable of receiving an incoming call. When a monitored signal experiences a signal strength below a predetermined level, the mobile device generates a corresponding record that is stored locally in memory. The record includes the measured signal strength and the location of the mobile device such as obtained from a local GPS module. Of course, location information can be obtained by other ways, either independently by the mobile device or incorporation with external devices, e.g. infrastructure equipment. The record will preferably contain additional information and parameters that can be of use in identifying areas of low signal strength and in determining whether appropriate remedies should be implemented. For example, the records may also include a time and date stamp, velocity of the mobile device, and the signal strength of other concurrently received RF signals, i.e. other base stations, at the time of the generation of the record. The signal strength may be periodically determined and corresponding records generated and stored at the mobile device. The information (records) transmitted to the database 20 can be processed by infrastructure or external equipment with processing capabilities in order to identify areas that are poorly served in terms of signal strength. Additional base stations and/or antennae could be strategically placed or existing base stations adjusted to serve areas of poor signal strength to remedy the quality of service issue.

While the mobile device continues to encounter low signal strength conditions, the records will continue to be stored locally in the mobile device. When the mobile device enters a relatively strong RF coverage area, the mobile unit can automatically transmit the stored records to database 20. The information can be transmitted by any appropriate data transmission method, e.g. short messaging system (SMS) protocol or a packet data transmission. The analysis of the transmitted records can be performed by network infrastructure equipment. This technique effectively gives each mobile device the capability to be an RF signal recorder.

FIG. 3 is a flow diagram of an exemplary method by which weak signal strength information is determined and stored in a mobile device. In step 100 a determination is made by control logic module 58 of mobile device 50 of whether a weak RF signal condition exists. This may for example be determined by comparing the measured signal strength to a predetermined level, or comparing the measured signal strength to a level that can be dynamically changed. Such a dynamic level may consist of an average signal level measured over a predetermined prior number of measurements or may consist of a level determined by the system infrastructure equipment that is transmitted to the mobile device. The weak RF signal conditions are continuously monitored at least at periodic time intervals. This operation is reflected by a NO determination by step 100 that returns to the beginning of the determination step to form a repeating closed loop. A YES determination by step 100 results in predetermined parameters relevant to the weak RF signal strength being saved in a record that is stored in memory 62 as indicated in step 102. In step 104 a control parameter N is set equal to 1. This control parameter functions as a flag, as will be described below, that indicates whether records are stored in memory 62 for transmission to the infrastructure equipment. Following step 104 the process returns to the beginning of the determination step 100.

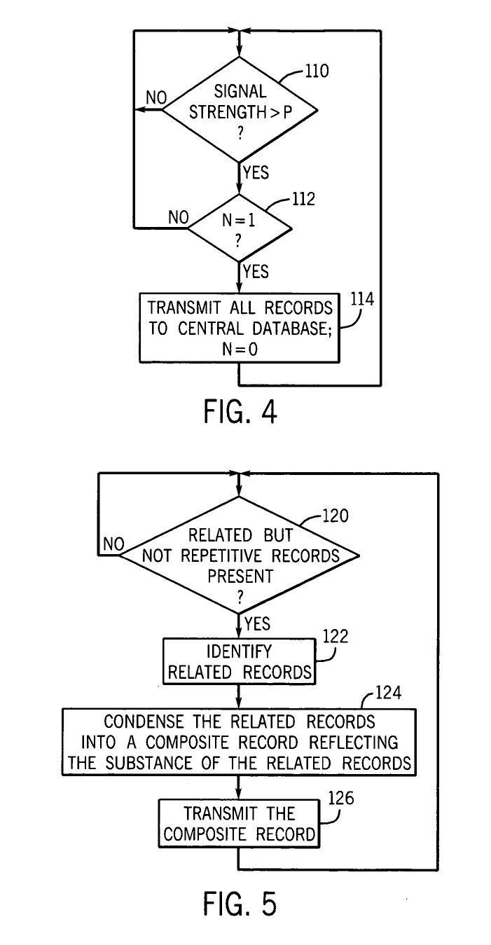

FIG. 4 is a flow diagram on an exemplary method by which signal strength records stored in the mobile device are transmitted to the infrastructure equipment. In step 110 a determination is made of whether the current signal strength as determined at the mobile device is greater than a predetermined level P. The RF signal conditions are continuously monitored so that a NO determination causes the process to return to the beginning of determination step 110. A YES determination by step 110 indicates that the currently measured signal strength by the mobile device is greater than P, where P is selected so that a YES determination will indicate a greater than average signal strength. Following a YES determination by step 110, a determination is made in step 112 of whether N is equal to 1. That is, a determination is made of whether the flag N is set to one as discussed above with regard to FIG. 3 indicating that signal strength records are stored in memory 62 of the mobile device 50 awaiting transmission to the infrastructure equipment. A NO determination by step 112 returns processing to the beginning of determination step 110. A YES determination by step 112 represents that the mobile unit is in an area having a strong signal strength and contains signal strength records awaiting transmission. In step 114, which follows a YES determination by step 112, the mobile device automatically begins transmission of all records stored in memory 62 to central database 20. The mode of transmission may be by any convenient protocol or format, e.g. SMS or other types of packet transmissions. Following the transmission of all records by the mobile device, the flag N is set equal to zero indicating that no records remain stored locally in memory that require transmission to the infrastructure equipment.

In the exemplary embodiment of the mobile device 50, the receiver module 56 periodically makes signal strength measurements that are transferred as an input to the control logic module 58 that makes the comparison of the measured signal strength versus a comparison level. If a record is to be generated and stored as indicated in FIG. 3, control logic 58 collects the required information to be stored in the record and writes the record for storage into memory 62. Location information as well as velocity can be provided by GPS module 60 to control logic module 58. The receiver module 56 is also preferably capable of concurrently receiving other base station signals and processing corresponding signal strength measurements. In accordance with process as described in FIG. 4, the control logic module 58 controls the flag N and causes the transmitter module 54 to automatically transmit the record(s) stored in memory 62 upon a YES determination by step 112.

FIG. 5 is a flow diagram illustrating an exemplary method by which the mobile device can minimize the amount of weak signal strength records to be transmitted to the infrastructure equipment. The objective is to minimize bandwidth requirements needed to handle the transmission of the signal strength records while substantially maintaining the content of the information contained in the records. In relationship to FIG. 4, the steps explained in FIG. 5 effectively take the place of step 114 of FIG. 4. A determination is made in step 120 of whether related, but not repetitive, records are stored in memory 62 prior to the transmission of these records. “Related records” mean records that have common parameter values and are related to each other so that a single record can reasonably incorporate the substance of the information carried by such records. For example, a series of records over a time interval may reflect a common event, e.g. a weak signal strength due to the mobile device experiencing a single shadow. These records can be compressed into a single record having the average value of the measured weak signal strengths, the start and end time of the event, location information of the mobile unit at the start and end of the event, and the average velocity of the mobile device during the event. Preferably such compressed records will be identified such as in a header transmitted with the record so that the infrastructure equipment will understand the format of the parameters and the corresponding values.

It is also foreseeable that the mobile device may travel the same routes repetitively such as going from home to work and returning from work and home. “Repetitive records” mean records that have common parameter values over a similar time interval or over the same route. If the signal strength measurements made while traveling from home to work are substantially similar to previous signal strength measurements made while traveling the same route, the system designer may elect not to have such repetitive data transmitted from the mobile device to the central database since such information would be substantially redundant. Intelligence implemented by the mobile device such as by control logic module 58 can suspend the transmission of the stored records even upon entering an area of strong signal strength when a repetitive route and time interval are present, e.g. going to or coming from work over the same route. Assuming the signal strength measurements during a just completed trip shows substantially the same areas of low signal strength as normally encountered during previous trips over the same route, such repeated records need not be transmitted. Such a determination can be made by comparing the records during the current trip to previous records retained in storage in memory 62 of prior trips. A comparison of GPS location data of the current trip and prior trips can confirm that the same route was traversed. A NO determination results in the process returning to the beginning of step 120 and the transmission of the records as explained in step 114.

A YES determination by step 120 indicates that related, but not repetitive, records are present. These related records are identified and grouped by step 122. Each group of related records is condensed into a composite record that reflects the substance of the related records in step 124. In step 126 the composite records are transmitted to the infrastructure database 20.

The apparatus 50 in one example employs one or more computer-readable signal-bearing media. The computer-readable signal-bearing media store software, firmware and/or assembly language for performing one or more portions of one or more embodiments of the invention. The computer-readable signal-bearing medium for the apparatus 50 in one example comprise one or more of a magnetic, electrical, optical, biological, and atomic data storage medium. For example, the computer-readable signal-bearing medium comprise floppy disks, magnetic tapes, CD-ROMs, DVD-ROMs, hard disk drives, and electronic memory. In another example, the computer-readable signal-bearing medium comprises a modulated carrier signal transmitted over a network comprising or coupled with the apparatus 50, for instance, one or more of a telephone network, a local area network (“LAN”), a wide area network (“WAN”), the Internet, and a wireless network.

The steps or operations described herein are just exemplary. There may be many variations to these steps or operations without departing from the spirit of the invention. For instance, the steps may be performed in a differing order, or steps may be added, deleted, or modified.

Although exemplary implementations of the invention have been depicted and described in detail herein, it will be apparent to those skilled in the relevant art that various modifications, additions, substitutions, and the like can be made without departing from the spirit of the invention and these are therefore considered to be within the scope of the invention as defined in the following claims.

We claim:

1. A method for collecting signal strength data for a wireless system comprising the steps of:
monitoring by a mobile device signal strength of a radio frequency (RF) signal received from a base station;
comparing a level of said signal strength to a comparison level;
if the level of said signal strength is less than the comparison level, creating and storing a record in the mobile device where the record includes a first signal strength level and parameters related to conditions existing at the time the comparing was done.

2. The method of claim 1 wherein the step of creating includes creating for each record location data identifying the location of the mobile device when the signal strength was less than the comparison level.

3. The method of claim 2 wherein the location data includes at least information relating to the latitude and longitude of the mobile device.

4. The method of claim 2 wherein the step of creating includes creating for each record time information identifying the time when the signal strength as determined by the mobile device was less than the comparison level.

5. The method of claim 2 wherein the step of creating includes creating for each record velocity information that identifies the velocity of the mobile device when the signal strength was less than the comparison level.

6. The method of claim 1 wherein the monitoring step further comprises concurrently monitoring a plurality of RF signals received by the mobile device from corresponding base stations where signal strength of the plurality of RF signals is also monitored.

7. The method of claim 6 wherein the step of creating includes creating for each record signal level information for each of the plurality of RF signals.

8. The method of claim 1 further comprising the steps of:
determining whether at least one record is stored in the mobile device that has not been previously transmitted to an infrastructure database;
determining whether the mobile device is in a strong signal area;
automatically transmitting the at least one record from the mobile device to the infrastructure database when a positive determination is made by each of said determining steps.

9. The method of claim 8 further comprising the steps of:
said storing step storing a plurality of records in the mobile device;
determining whether related, but not repetitive, records are stored;
condensing a plurality of related records into a single composite record that reflects the substance of the related records;
transmitting the composite record from the mobile device to the infrastructure database and not transmitting the plurality of related records from which the single composite record was condensed.

10. A wireless mobile device comprising:
an RF transmitter and receiver;
the receiver adapted to monitor signal strength of a radio frequency (RF) signal received from a base station;
a control logic module adapted to compare a level of said signal strength to a comparison level;
a memory module;
the control logic module being adapted to create and store a record in the memory module where the record includes a first signal strength level and parameters related to conditions existing at the time the comparing was done, the control logic module creating and storing the record if the level of said signal strength is less than the comparison level.

11. The wireless mobile device of claim 10 wherein the control logic module is adapted to create and store a record that contains location data identifying the location of the mobile device when the signal strength was less than the comparison level, the location data including at least information relating to the latitude and longitude of the mobile device.

12. The wireless mobile device of claim 11 wherein the control logic module is adapted to create and store a record that includes for each record time information identifying the time when the signal strength as determined by the mobile device was less than the comparison level.

13. The wireless mobile device of claim 11 wherein the control logic module is adapted to create and store a record that includes velocity information that identifies the velocity of the mobile device when the signal strength was less than the comparison level.

14. The wireless mobile device of claim 10 wherein the receiver is adapted to concurrently monitor a plurality of RF signals received by the mobile device from corresponding base stations where signal strength of the plurality of RF signals is also monitored.

15. The wireless mobile device of claim 14 wherein the control logic module is adapted to create and store a record that includes for each record signal level information for each of the plurality of RF signals.

16. The wireless mobile device of claim 10 wherein the control logic module further comprises:
means for determining whether at least one record is stored in the mobile device that has not been previously transmitted to an infrastructure database;
means for determining whether the mobile device is in a strong signal area;
means for causing the transmitter to automatically transmit the at least one record from the mobile device to the infrastructure database when a positive determination is made by each of said determining means.

17. The wireless mobile device of claim 16 wherein the control logic module further comprises:
means for storing a plurality of records in the mobile device;
means for determining whether related, but not repetitive, records are stored;
means for condensing a plurality of related records into a single composite record that reflects the substance of the related records;
means for causing the transmitter to automatically transmit the composite record from the mobile device to the infrastructure database and causing the transmitter to not transmit the plurality of related records from which the single composite record was condensed.

18. An article, comprising:
one or more computer-readable signal-bearing media; and
means in the one or more media for monitoring by a mobile device signal strength of a radio frequency (RF) signal received from a base station;
means in the one or more media for comparing a level of said signal strength to a comparison level;
means in the one or more media for creating and storing a record in the mobile device where the record includes a first signal strength level and parameters related to conditions existing at the time the comparing was done, if the level of said signal strength is less than the comparison level.

19. The article of claim 18 further comprising:
means in the one or more media for determining whether at least one record is stored in the mobile device that has not been previously transmitted to an infrastructure database;
means in the one or more media for determining whether the mobile device is in a strong signal area;
means in the one or more media for automatically transmitting the at least one record from the mobile device to the infrastructure database when a positive determination is made by each of said determining steps.

20. The article of claim 19 further comprising:
means in the one or more media for storing a plurality of records in the mobile device;
means in the one or more media for determining whether related, but not repetitive, records are stored;
means in the one or more media for condensing a plurality of related records into a single composite record that reflects the substance of the related records;
means in the one or more media for transmitting the composite record from the mobile device to the infrastructure database and not transmitting the plurality of related records from which the single composite record was condensed.
